(19) United States
(12) Patent Application Publication
(10) Pub. No.: US 2004/0123467 A1
(43) Pub. Date: Jul. 1, 2004

(54) Razor

(76) Inventor: Nini Policappelli, Los Angeles, CA (US)

Correspondence Address: GREENBERG TRAURIG LLP, 2450 COLORADO AVENUE, SUITE 400E, SANTA MONICA, CA, 90404, US

(21) Appl. No.: 10/647,025

(22) Filed: Aug. 22, 2003

Related U.S. Application Data
(60) Provisional application No. 60/405,827, filed on Aug. 23, 2002.

(51) Int. Cl. B26B 21/00

(52) U.S. Cl. 30/50

(57) ABSTRACT

The present invention is directed to a razor, which includes a handle and a head connectable with the handle. The head includes a series or set of blades directed laterally relative to the handle. The blades are arranged preferably in multiple sets in the head and the blades have a flat portion and a cutting edge. Each blade set is arranged so that the flat portion of the blades in a first set is non-parallel to a flat portion of the blades in a second set. The sets are preferably in an angular relationship relative to each other. In other cases the there can be two blade sets which are parallel to each other but are in an oppositely directed relationship to each other.

### RELATED APPLICATION

This application claims priority to provisional application 60/405,827 filed Aug. 23, 2002, entitled “A Razor”. The contents of that application are incorporated by reference herein.

### BACKGROUND OF THE INVENTION

### Field of the Invention

This invention relates to a razor. In particular it relates to an improvement of the cutting portion, blade holding portion, or the head of a razor.

Many different kinds of razors for personal body user are known. Each of these razors have different kinds of heads with different blade constructions. Some of these different heads involve a single blade or multiple blade sets. The razors may be of a disposable kind wherein the entire razor, including the handle, the head and the blade are discarded after use. In other cases, the razor may have blades which can be used multiple times and/or a head which can receive new blades. Old blades which are blunted are removed from a head and replaced with new blades.

This invention relates to a razor generally, and in particular to the head and blade construction of a razor.

### SUMMARY

According to the invention there is provided a razor, which includes a handle and a head connectable with the handle. The head includes a series or set of blades directed laterally relative to the handle. The blades are arranged preferably in multiple sets in the head and the blades have a flat portion and a cutting edge.

Each blade set is arranged so that the flat portion of the blades in a first set is non-parallel to a flat portion of the blades in a second set. The sets are preferably in an angular relationship relative to each other. In other cases the there can be two blade sets which are parallel to each other but are in an oppositely directed relationship to each other.

In a preferred form of the invention the flat portion of the blades on the first set and the second set are offset at about 60° relative to each other. There is also a third set of blades which is offset at about 60° relative to the first and second sets. This 60° offset is measured as the degrees internally between each set of blades. In another form of the measurement of the degrees can be the outside degrees. In this sense a first set of blades is offset at about 120° relative to the second set of blades and a second set of blades is offset 120° relative to a third set of blades. The blade sets form essentially an equilateral triangle. There is a common longitudinal axis running through the center of the three blade sets.

In other forms of the invention there could be four sets of blades, each arranged to form the side of a rectangle. Ideally, the blades form the sides of a square.

In yet other forms of the invention there could be multiple, different sets of blades, for instance, 5, 6, 7 or 8 sets of blades, arranged about an axis running through the head in which the blades are mounted.

In a preferred form of the invention the sets of blades are held in a mounting, and the mounting is located with the head, the head being transversely formed or located relative to the handle.

The mounting is relatively rotatable in the head, and thereby the sets of blades are rotatable relative to the head. As such, in a first configuration the edges of the first blade set extend for permitting cutting on a surface, for instance the hair on the skin of a user. In a second configuration, the mounting is turned in the head so that a second or third set of blades can extend forward to implement cutting of hair on the skin of the user. The rotation of the blades sets is effected by rotating the mounting about the axis running through the axis of the head. In this manner several blade sets are available for each razor.

In yet a further preferred form of the invention the blades in one or more sets are held in a mounting in an operational withdrawn or retracted position and are selectively moveable to an extended non-operational position to permit cleaning. In the withdrawn or retracted position the blades can be located in the mounting for use in the cutting relationship.

The movement between the extended and retracted position is effected by a hinge mechanism with the mounting. The hinge mechanism is formed between the mounting and a structure supporting each blade set. The sets are moveable between the retracted and extended position through the hinge effect.

In some forms of the invention there is a spring associated with the mechanism to permit opening about the hinge when the configuration is released in the mounting. There are also locking elements for engagement to prevent the opening of the blade set from the mounting inadvertently. Release of the locking elements permits for the blades to move to the extended position in unlocked position and thereby permit cleaning of the blades in the extended position.

The invention is further described with reference to the accompanying drawings.

### BRIEF DESCRIPTION OF THE DRAWINGS

FIG. 1 is a front view of a razor showing a handle and a head mounted transversely on top of the handle.

FIG. 2 is a side view of a curved handle as shown in FIG. 1. A head is mounted at the top with a mounting inside the head in which there is arranged four sets of blades rectangularly about an axis through the head.

FIG. 3 is a front sectional view of one set of blades.

FIG. 4 is a front view of a second set of blades.

FIG. 5 is an end view of a set of blades in a retracted position so that they are operational to permit cutting, for instance of hair on the skin of a user.

FIG. 6 is an end view of the blades in a extended position to permit cleaning, the extension being effected by a hinge operation.

FIG. 7 is collectively different components making up a blade set mounted in a mounting and using a spring mechanism and configured as a hinge to permit retraction and extension as necessary.

FIG. 8 is a perspective view of one form of the blades arranged in a set, the blades being arranged in a triangular mounting about a central axis which is directed laterally through the head.

FIG. 9 is a different mounting configuration.

FIG. 10 is yet a further mounting configuration.

FIG. 11 is a front view of a different configuration of a head and a handle showing a rotatable head on the handle.

FIG. 12 is a perspective view of the razor illustrated in FIG. 11.

FIG. 13 is an example of four sets of blades arranged in a rectangular mounting about an axis and being located in the mounting in the head.

FIG. 14 is a perspective view showing three sets of blades.

FIG. 15 is a perspective view showing two blade sets parallel to each other and oppositely set out relative to each other.

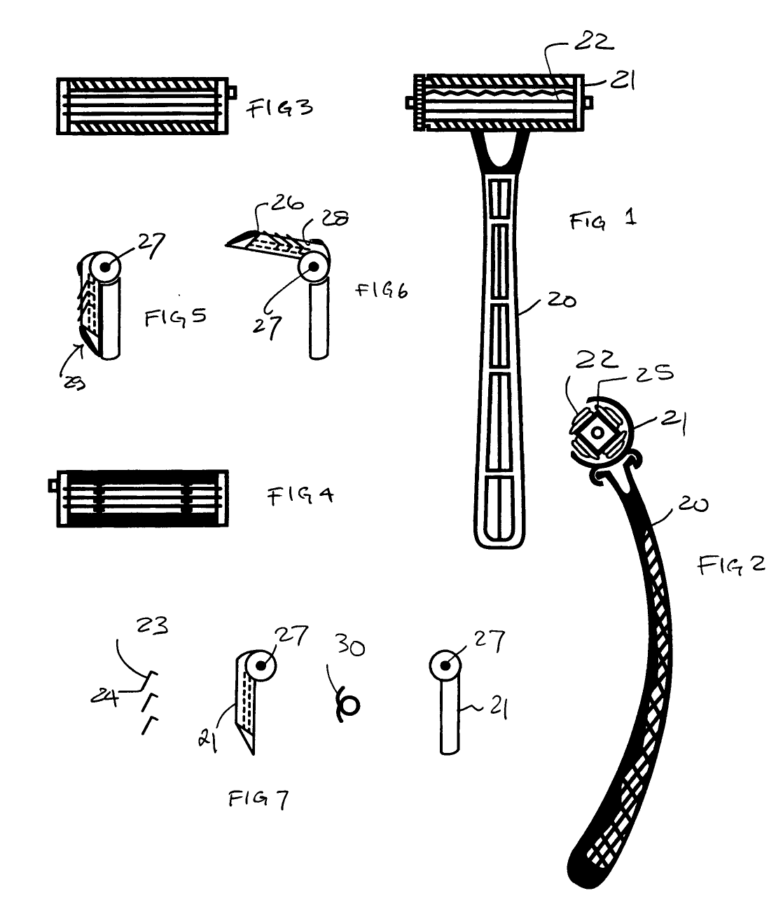

### DETAILED DESCRIPTION OF THE PREFERRED EMBODIMENTS

The invention is now further described as an illustration only.

A razor includes a handle 20 and a head 21 connectable with the handle. The head includes a series or set of blades 22 directed laterally relative to the handle. The blades 22 are arranged in multiple sets in the head. The blades 22 have a flat portion 23 and a cutting edge 24.

Each blade set 22 is arranged so that the flat portion 23 of the blades in a first set is non-parallel to a flat portion of the blades in a second set. The sets are in an angular relationship relative to each other.

In other cases there can be two blade sets 22 which are parallel to each other but are in an oppositely directed relationship to each other. This is shown in FIG. 15.

In FIGS. 8, 9, 10 and 14 the flat portion of the blades on the first set and the second set are offset at about 60° relative to each other. There is also a third set of blades which is offset at about 60° relative to the first and second sets. This 60° offset is measured as the degrees internally between each set of blades. In another form of the measurement of the degrees can be the outside degrees. In this sense a first set of blades is offset at about 120° relative to the second set of blades and a second set of blades is offset 120° relative to a third set of blades. The blade sets 22 can form internally essentially an equilateral triangle. There is a common longitudinal axis running through the center of the three blade sets.

In other examples, for instance in FIGS. 2, 12 and 13 there are four sets of blades, each arranged to form the side of a rectangle. Ideally, the blades form the sides of a square.

In yet other examples there are multiple, different sets of blades, for instance, 5, 6, 7 or 8 sets of blades, arranged about an axis running through the head in which the blades are mounted.

The sets of blades are held in or with a mounting or base 25, and the mounting or base is located with the head 21, the head being transversely formed or located relative to the handle 20.

The mounting 25 is relatively rotatable in the head 21, and thereby the sets of blades are rotatable relative to the head. As such, in a first configuration the edges of the first blade set extend for permitting cutting on a surface, for instance the hair on the skin of a user. In a second configuration, the mounting is turned in the head so that a second or third set of blades can extend forward to implement cutting of hair on the skin of the user. The rotation of the blades sets is effected by rotating the mounting about the axis running through the axis of the head. In this manner several blade sets are available for each razor. The location of the blades of each set can be based in the head in different positions so that each set of blades can be used as needed.

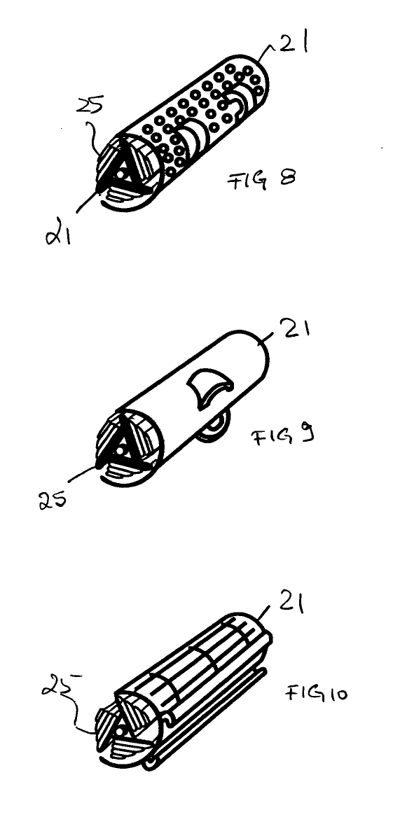

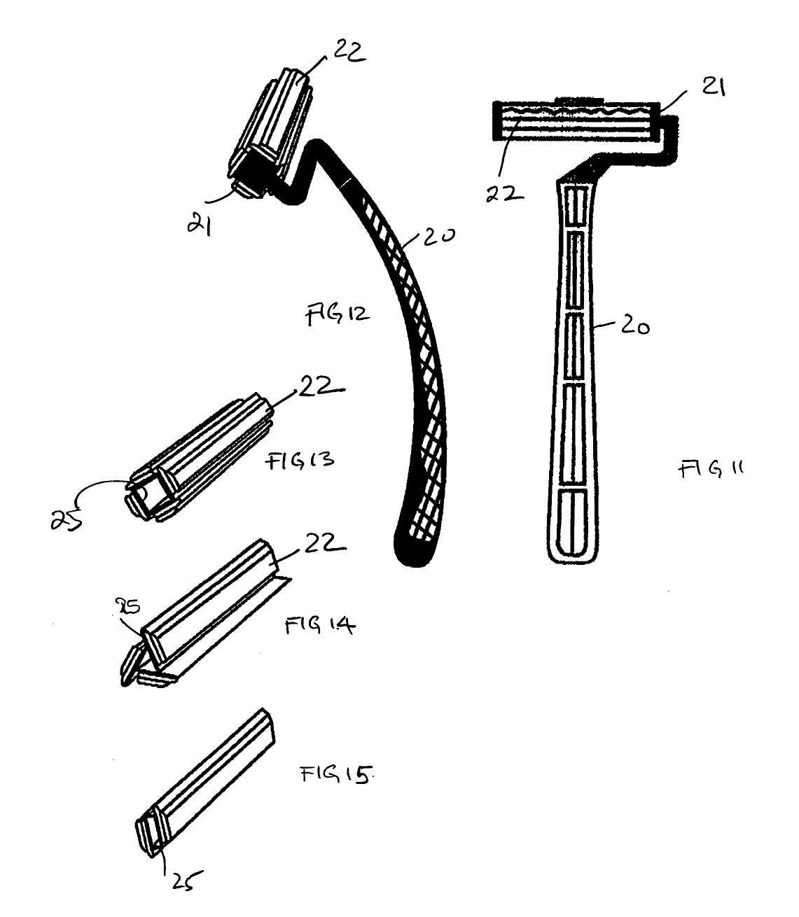

The blades in one or more sets are held in a mounting in an operational withdrawn or retracted position and are selectively moveable to an extended non-operational position to permit cleaning. In the withdrawn or retracted position the blades can be located in the mounting for use in the cutting relationship. This is illustrated in FIGS. 5 to 7.

The movement between the extended and retracted position 26 is effected by a hinge mechanism 27 with the mounting. The hinge mechanism is formed between the mounting and a structure 28 supporting each blade set. The sets are moveable between the retracted position 29 and extended position 26 through the hinge effect.

There is a spring 30 associated with the mechanism to permit opening above the hinge when the configuration is released in the mounting. There are also locking elements for engagement to prevent the opening of the blade set from the mounting inadvertently. Release of the locking elements permits for the blades to move to the extended position in unlocked position and thereby permit cleaning of the blades in the extended position.

Many other forms of the invention exist. The heads of the razor are flexible and can move in and/or out and/or up and/or down. The head can move so that movement can be effected relative to the interface on which cutting can be achieved. The head may swivel relative to the handle. The head can follow the contour of the body.

The invention to be determined by the following claims.

I claim:

1. A razor comprising:
a) a handle;
b) a head connectable with the handle, the head including at least two blades and the head being directed laterally relative to the handle;
c) the blades being arranged in at least two sets in the head;
d) the blades having a flat portion and a cutting edge; and
e) the sets being arranged so that the flat portion of the blade in a first set is non-parallel to the flat portion of the blade in a second set.

2. A razor comprising:
a) a handle;
b) a head connectable with the handle, the head including at least two blades and the head being directed laterally relative to the handle;
c) the blades being arranged in at least two sets in the head;
d) the blades having a flat portion and a cutting edge; and
e) the sets being arranged so that the flat portion of the blade in a first set is parallel to the flat portion of the blade in a second set, the respective cutting edges of each of the blades of the first set and the second set being directed oppositely to each other.

3. A razor comprising a handle and a head connectable with the handle, the head including a set of blades directed laterally relative to the handle, and the blades being arranged preferably in multiple sets in the head and the blades have a flat portion and a cutting edge, each blade set being arranged so that the flat portion of the blades in a first set is non-parallel to a flat portion of the blades in a second set.

4. A razor as claimed in any one of claims 1 to 3 wherein the sets are preferably in an angular relationship relative to each other.

5. A razor as claimed in any one of claims 1 to 3 where there are two blade sets which are parallel to each other but are in an oppositely directed relationship to each other.

6. A razor as claimed in any one of claims 1 to 5 wherein the sets of blades are held in a mounting, and the mounting is located with the head, the head being transversely formed or located relative to the handle.

7. A razor as claimed in claim 5 wherein the mounting is relatively rotatable in the head, and thereby the sets of blades are rotatable relative to the head.

8. A razor as claimed in any one of claims 1 to 7 wherein the blades in one or more sets are held in a mounting in an operational withdrawn or retracted position and are selectively moveable to an extended non-operational position to permit cleaning, the movement between the extended and retracted position being effected by a hinge mechanism with the mounting.
